(19) United States
(12) Patent Application Publication
(10) Pub. No.: US 2025/0078431 A1
(43) Pub. Date: Mar. 6, 2025

(54) SYSTEMS AND METHODS FOR MANIPULATING IMAGES BY COMPARING MAPPED STYLES AND DIMENSIONS USING MACHINE LEARNING MODELS

(71) Applicant: Toyota Research Institute, Inc., Los Altos, CA (US)

(72) Inventors: Youngseung Jeon, Sunnyvale, CA (US); Matthew K. Hong, Mountain View, CA (US); Yin-Ying Chen, San Jose, CA (US); Shabnam Hakimi, San Francisco, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 18/539,748

(22) Filed: Dec. 14, 2023

Related U.S. Application Data
(60) Provisional application No. 63/535,820, filed on Aug. 31, 2023.

(51) Int. Cl. G06T 19/20; G06V 10/74; G06V 10/762; G06V 10/764; G06V 10/77; G06V 10/776; G06V 20/70

(52) U.S. Cl. CPC G06T 19/20; G06V 10/761; G06V 10/762; G06V 10/764; G06V 10/7715; G06V 10/776; G06V 20/70; G06T 2219/2024

(57) ABSTRACT

Systems, methods, and other embodiments described herein relate to organizing and altering selected images from a style map with learning models through factoring style dimensions. In one embodiment, a method includes generating a style map by transforming and clustering information from an image dataset with a visualization model within a computation space having reduced dimensionality, and the style map includes style features derived from the image dataset. The method also includes comparing images selected from the style map using scores for dimensions associated with semantic attributes to form a comparison map. The method also includes mixing visual styles of the images from the comparison map with a generative model that computes representation interpolations within a latent space, the generative model outputting stylized images in an array. The method also includes communicating the array to a development system.

### CROSS-REFERENCE TO RELATED APPLICATIONS

This application claims the benefit of U.S. Provisional Application No. 62/535,820 filed on Aug. 31, 2023, which is herein incorporated by reference in its entirety.

### TECHNICAL FIELD

The subject matter described herein relates, in general, to manipulating images, and, more particularly, organizing and altering selected images from a style map with learning models through factoring style dimensions.

### BACKGROUND

Designers using tools to model and create objects involves searching datasets that are vast and numerous. The searching may involve browsing and textual prompts that specify parameters for a design. For example, a designer during conceptualization searches and curates design sets from data repositories (e.g., a product catalog, Pinterest, etc.) after inputting a design prompt (e.g., “design a rugged vehicle”). This approach can encounter difficulties from deriving meaning and interpretations about semantic relationships between object designs and creative objectives. A semantic relationship between object designs may be important when the relationship influences purchase decisions and user satisfaction.

In various implementations, systems utilize a model that associates inspired designs with semantics. However, associating inspirational designs to semantics can involve speculation and influences from designer intuition and domain knowledge that create bias and limit creativity. As such, speculation and designer inputs can lead systems to mistakenly forego systematic design exploration and investigation involving semantics that represent diverse perspectives. Foregoing certain design exploration of datasets can cause additional design cycles and deployment delays from seeking feedback later in the production phases, thereby raising costs. Therefore, systems encounter difficulties at inspiring diverse designs using semantic relationships that factor perception while mitigating design biases.

### SUMMARY

In one embodiment, example systems and methods relate to organizing and altering selected images from a style map with learning models through factoring style dimensions. In various implementations, systems assessing user inputs for design are biased (e.g., design fixation) and lack effective feedback from designers, stakeholders (e.g., marketing, sales, executives, etc.) and customers. For product design, relationships about product descriptions (e.g., color) can lack certain perceptual features associated with a design. Furthermore, machine learning (ML) models including interpretation models (e.g., large language models (LLM)) and models that create images from text and visual inputs encounter unique difficulties for professional designers. For example, designers have constraints over exploring and browsing a design through an intended manner since design models produce images using certain inputs. Additionally, language models and generative models may lack specifications about internal operations and approaches, thereby limiting the interpretability of the system for design professionals.

Therefore, in one embodiment, a design system generates a style map for organizing images, compares images selected from the style map using scored dimensions, and mixes visual styles through interpolation that improves design creativity. In this way, the design system supports designers with organizing alternative designs that are machine-generated assessments for aligning semantics, perception, and visual features while factoring feedback with the scoring. Here, the design system generates the style map with a visualization model including a vision transformer to identify distinct styles and style features about the images and display organized results. In one approach, the design system factors stakeholder feedback for the scoring and displays a comparison map when a design process commences to reduce development costs and design iterations. Regarding mixing the visual styles, a generative model is trained to align designs with human interpretations of semantic attributes through scoring and displaying stylized images. Accordingly, the design system displays the style map, the comparison, and the stylized images from mixing to inspire unique designs.

In various implementations, compared images selected from the style map represent aggregated interpretations of design alternatives from humans or a learning model. Displaying the aggregated interpretations with the comparison map increases the organization and interpretability of the design space, thereby improving creativity. Furthermore, designers build on the visual information to experiment with visual concepts that are novel using artificial intelligence (AI) that is generative. As such, the design system aids designers in generating alternative designs aligned with a design direction. Therefore, the design system maps style for a vast amount of images and integrates design feedback sooner with directed applicability of AI, thereby reducing development times and increasing efficiency through reliable consensus building among stakeholders.

In one embodiment, a design system to organize and alter selected images from a style map with learning models through factoring style dimensions is disclosed. The design system includes a memory having instructions that, when executed by a processor, cause the processor to generate a style map by transforming and clustering information from an image dataset with a visualization model within a computation space having reduced dimensionality, and the style map includes style features derived from the image dataset. The instructions also include instructions to compare images selected from the style map using scores for dimensions associated with semantic attributes to form a comparison map. The instructions also include instructions to mix visual styles of the images from the comparison map with a generative model that computes representation interpolations within a latent space, the generative model outputting stylized images in an array. The instructions also include instructions to communicate the array to a development system.

In one embodiment, a non-transitory computer-readable medium to organize and alter selected images from a style map with learning models through factoring style dimensions and including instructions that, when executed by a processor, cause the processor to perform one or more functions is disclosed. The instructions include instructions to generate a style map by transforming and clustering information from an image dataset with a visualization model within a computation space having reduced dimensionality, and the style map includes style features derived from the image dataset. The instructions also include instructions to compare images selected from the style map using scores for dimensions associated with semantic attributes to form a comparison map. The instructions also include instructions to mix visual styles of the images from the comparison map with a generative model that computes representation interpolations within a latent space, the generative model outputting stylized images in an array. The instructions also include instructions to communicate the array to a development system.

In one embodiment, a method for organizing and altering selected images from a style map with learning models through factoring style dimensions is disclosed. In one embodiment, the method includes generating a style map by transforming and clustering information from an image dataset with a visualization model within a computation space having reduced dimensionality, and the style map includes style features derived from the image dataset. The method also includes comparing images selected from the style map using scores for dimensions associated with semantic attributes to form a comparison map. The method also includes mixing visual styles of the images from the comparison map with a generative model that computes representation interpolations within a latent space, the generative model outputting stylized images in an array. The method also includes communicating the array to a development system.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a design system that is associated with altering images by machine learning (ML) models using design parameters, semantic attributes, and factoring scored dimensions.

FIG. 2 illustrates one embodiment of an interface generated by the design system as a design tool displaying a style map, a comparison map, and a mixing panel.

FIG. 3 illustrates one embodiment of the ML pipeline for exploring, comparing, and manipulating images through user and model feedback.

FIG. 4 illustrates one embodiment of a method that is associated with generating the style map, comparing images, and mixing visual style by the ML models for a design system.

### DETAILED DESCRIPTION

Systems, methods, and other embodiments associated with organizing and altering selected images from a style map with learning models through factoring style dimensions are disclosed herein. In various implementations, systems that assist designers with researching concepts efficiently encounter difficulties managing and organizing vast datasets. These systems can also have biases toward designer preferences without factoring outside feedback. Additionally, machine learning (ML) models implementing large language models (LLMs) and generative models that create high-fidelity images for designers encounter difficulties from text and visual inputs involving creative design. For example, designers have limited control over exploring a design space since generative models produce images using inputs (e.g., parameters, keywords, etc.) that are well-defined and limited. Furthermore, systems can forego identifying feedback sources about semantics represented through the design outcomes from the black-box nature of LLMs and generative models, thereby reducing insight about model interpretability and processes.

Therefore, in one embodiment, a design system generates a style map that distinguishes style features (e.g., boxy, curvy, symmetrical, etc.) with a visualization model that transforms, organizes, and clusters images from a vast dataset. The design system forms a comparison map of images selected from the style map through a design interface that exhibits scored dimensions representing semantic attributes (e.g., object qualities, sporty, luxury, etc.). In one approach, the design system computes the scored dimensions by acquiring coordinate values from stakeholders or a learning model. Here, the learning model may classify the images selected or estimate semantic distances for scoring relative to semantic attributes. Furthermore, a generative model (e.g., a diffusion model) can mix the visual styles of the images selected through representation interpolations. The generative model outputs stylized images for downstream tasks by a development system (e.g., prototyping). Accordingly, the design system inspires and organizes new designs efficiently with learning models that generate a style map and mix styles for images selected from the comparison map.

In various implementations, the design system extracts distinct styles about the images for the style map and the style features with a visualization model having a vision transformer. Here, the vision transformer may implement self-attention processing that derives attention weights between pixels in an image to identify the distinct styles. In one approach, a neighbor embedding model reduces the dimensionality of the vision transformer to simplify and improve extraction computations. The design system can adapt clustering of the images from the dataset through factoring the distinct styles identified by the visualization model. Thus, the design system implements learning models that map style for an extensive amount of images and mix designs using a vision transformer while integrating stakeholder feedback, thereby improving design creativity and reducing development times.

It will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements.

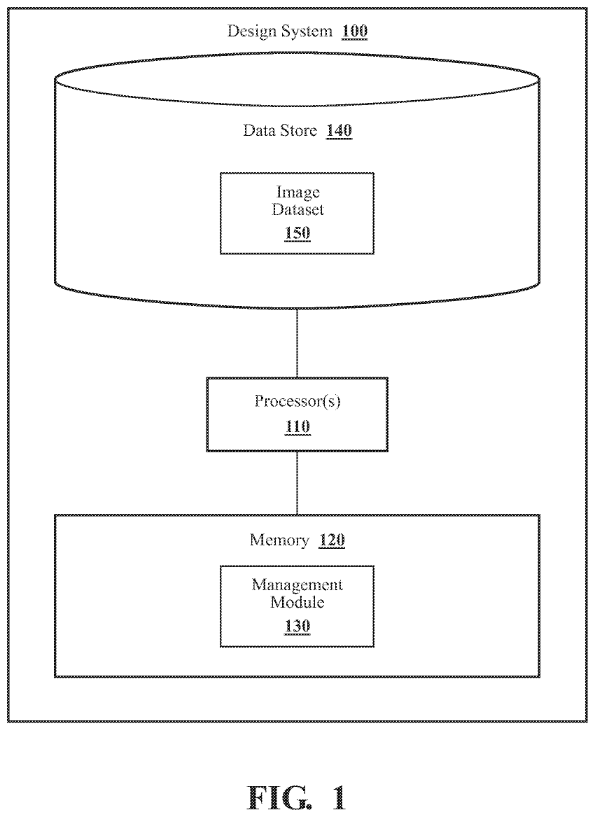

With reference to FIG. 1, one embodiment of the design system 100 that is associated with altering images by a ML model using design parameters, semantic attributes, and factoring scored dimensions is illustrated. The design system 100 is shown as including a processor(s) 110 that the design system 100 may access through a data bus or another communication path. In one embodiment, the design system 100 includes a memory 120 that stores a management module 130. The memory 120 is a random-access memory (RAM), a read-only memory (ROM), a hard-disk drive, a flash memory, or other suitable memory for storing the management module 130. The management module 130 is, for example, computer-readable instructions that when executed by the processor(s) 110 cause the processor(s) 110 to perform the various functions disclosed herein. In one approach, the design system 100 generates a style map having derived style features by transforming and clustering an image dataset 150 using a visualization model within a space having reduced dimensionality. The management module 130 can compare images selected from the style map using scored dimensions associated with the semantic attributes and form a comparison map. Regarding additional design processing, the design system 100 mixes visual styles of the images selected with a generative model that computes representation interpolations within a latent space and outputs stylized images, such as in an array. The design system 100 may communicate the outputs to a development system (e.g., prototyping) for processing additional tasks (e.g., material selection). Thus, the design system 100 and the management module 130 efficiently explore, organize, compare, and alter images by style features and dimensions using learning models that improves design creativity.

Moreover, in one embodiment, the design system 100 includes a data store 140. In one embodiment, the data store 140 is a database. The database is, in one embodiment, an electronic data structure stored in the memory 120 or another data store and that is configured with routines that can be executed by the processor(s) 110 for analyzing stored data, providing stored data, organizing stored data, and so on. Thus, in one embodiment, the data store 140 stores data used by the management module 130 in executing various functions. In one embodiment, the data store 140 further includes image dataset 150 that the design system 100 organizes, scores, and manipulates. For example, the image dataset 150 are designs for clothes, vehicle parts, etc. that are manipulated and altered to generate various style alternatives using ML models, including creating completely new images that are tangentially related while still relevant to design inputs. Accordingly, the design system 100 inspires new designs efficiently by implementing ML models directed toward organizing, collaborating, and altering creative designs.

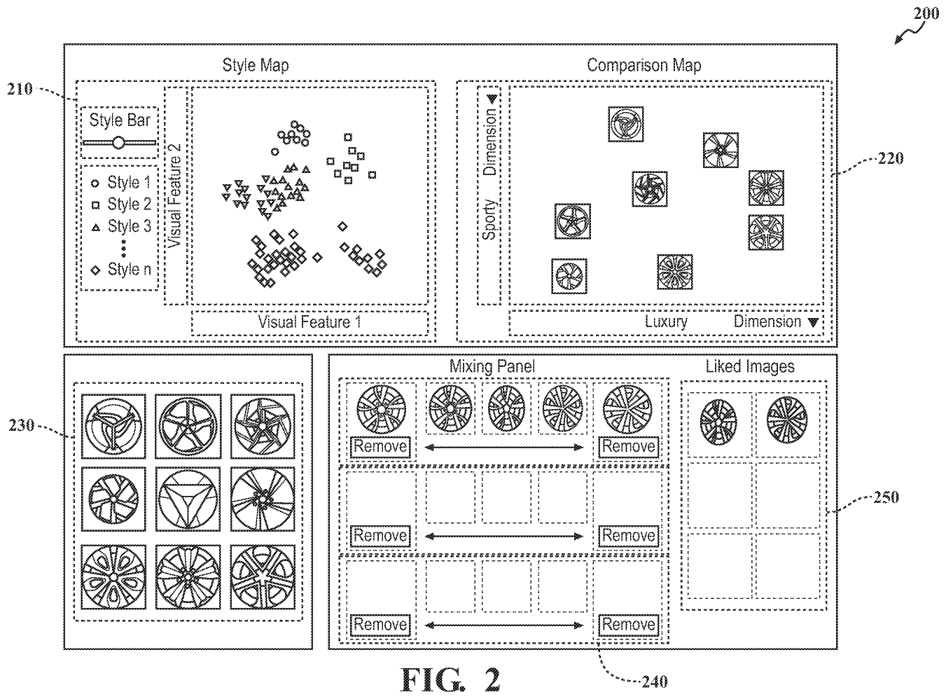

Now turning to FIG. 2, one embodiment of an interface 200 generated by the design system 100 as a design tool displaying a style map, a comparison map, and a mixing panel is illustrated. Here, the design system 100 may facilitate a design direction and inspire new design choices that closely fit design inputs, including creating substantially new images that are unrelated while relevant to design inputs. In one approach, the design tool assists designers to efficiently browse and mix-and-match style examples while factoring scores and altering designs using ML models. In various implementations, the management module 130 includes instructions that cause the processor(s) 110 to generate, in part, an interface including panels for a style map 210, a comparison map 220, an image database 230, a mixing panel 240, and liked images 250 associated with organizing, scoring, and altering images. The style map 210 may include selected styles 1 . . . n organized and displayed in a two-dimensional (2D) map that clusters by visual features 1 and 2 (e.g., colors, patterns, etc.). As further explained below, a visualization model may include a vision transformer that extracts and identifies styles from the image dataset 150.

As additional details, the design system 100 maps style features in clusters according to visual features on style map 210 and selected styles 1 . . . n. A style can be a distinct representation of design artifacts with similar visual features that may be grouped. For example, design artifacts with a curved edge is a style group which human judgment can categorize under a style group for curved edges. When a clustering scheme is increased (e.g., 6 to 10 clusters), design artifacts may include curved edges that are left-oriented and right-oriented belonging to different style groups. Furthermore, a visual feature can be a pattern, shape, color, configuration, and so on, perceivable from the content of an image.

Moreover, the interface 200 may allow style selections with a style bar that is user-selectable. The interface 200 can also implement a dial, a drop box, a text field(s), or any other interface control for selecting styles 1 . . . n. Here, a style for a bumper may be boxy, curvy, symmetrical, etc. while a visual feature describes a pattern, shape, color, configuration, and so on. Accordingly, the design system 100 includes ML models that execute computations to identify, cluster, and map visual features efficiently from an image database that is diverse and extensive, thereby improving design creativity and efficiency.

Regarding the comparison map 220, the interface 200 displays images on a 2D spatial layout of selections from the style map 210 using scored dimensions. For example, the dimensions are semantic attributes sporty, luxury, rugged, etc. that are numerical x and y coordinates. As further explained below, the design system 100 can acquire the metrics about the semantic attributes from stakeholder or machine-generated feedback of the selected images. For instance, a model such as a data-driven model, contrastive language-image pre-training (CLIP), a vision and language model, etc. estimates the scores dynamically by comparing and mapping images on the comparison map 220 for a design process. Scoring can factor metrics representing certain behavioral, attitudinal, and physiological responses of individuals (e.g., consumer interactions with a product webpage).

Moreover, the comparison map 220 allows users (e.g., stakeholders, consumers, managers, etc.) to specify and customize semantic keywords, labels, etc. as dimensions on the x-axis and y-axis. Furthermore, the comparison map 220 allows adding further dimensions (e.g., z-axis) for exploring designs in dimensional spaces that have additional complexities such as costs. In one approach, the design system 100 places images dynamically according to scores for selected dimensions acquired from stakeholders or a learning model. The design process can advance by selecting images on the comparison map 220 for display and alterations on the mixing panel 240.

Additional details about the mixing panel 240 may include the following. The design system 100 can generate a panel for design experimentation by mixing styles using two or more selected images. As explained below, an interpolation model can execute generative operations that integrate visual elements between two images at various proportions (e.g., 25/75, 50/50, 75/25, etc.). Here, the interpolation model is trained to learn internal representations within a latent space for transferring between styles. The management module 130 displays the results of the interpolation and mixing on a space for the mixing panel 240. Furthermore, the design system 100 can move images through a button click (e.g., a like button) into the liked images 250. In one approach, designers select interpolated images as a new input(s) to generate image combinations that are diverse for additional experimentation and exploration.

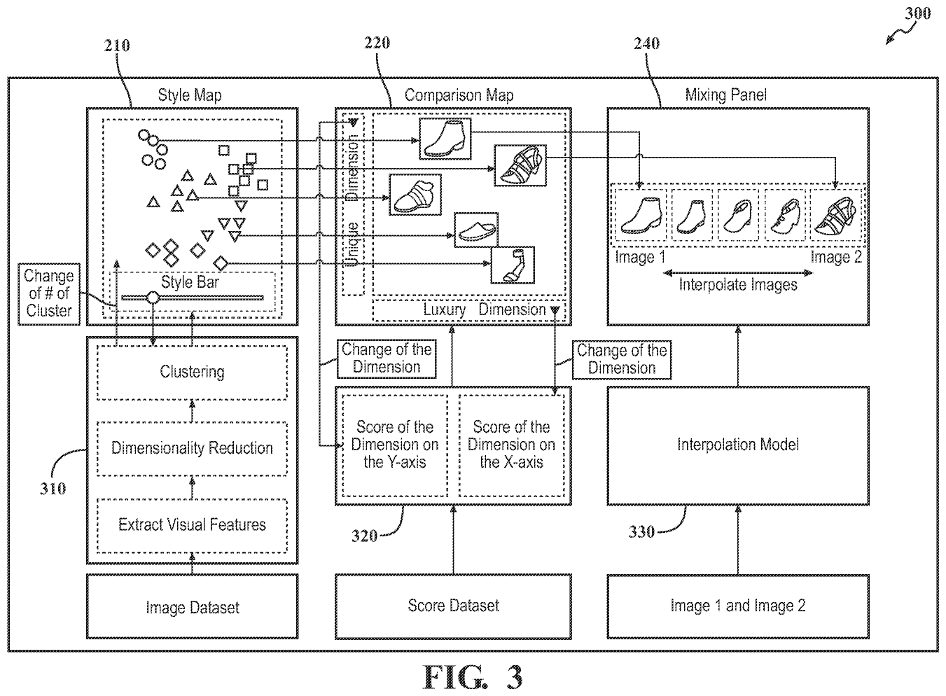

Turning now to FIG. 3, one embodiment of a ML pipeline 300 for exploring, comparing, and manipulating images through user and model feedback is illustrated. In the examples given herein, manipulating includes creating and altering new images that are related to design inputs. For example, inputs include the image dataset 150, a quantity from a style control, and selected images that are scored along dimensions representing semantic attributes from a user (e.g., decision-makers, designers, stakeholders, etc.) or a learning model. The selected images from the style map 210 and the comparison map 220 are inputted to the mixing panel 240. In the ML pipeline 300, the style stage 310 processes an image dataset inputted having an image pool that is diverse and vast (e.g., ten thousand wheel designs) to a visualization model (e.g., visual transformer model, a neural network (NN), a color distribution model, etc.) that extracts visual features. For example, source vision transformers (ViT) implement self-attention processing through a series of transformer blocks. A transformer block consists of two sub-layers: a multi-head self-attention layer and a feed-forward layer. The self-attention layer computes attention weights per pixel in the image according to relationships with all other pixels. A feed-forward layer applies a non-linear transformation to the output of the self-attention layer. Furthermore, multi-head attention extends computations by allowing attention to different parts of an input sequence simultaneously. The output of the vision transformers may be a class prediction by a classification head.

For the ML pipeline 300, the style map 210 can extract distinct styles about the images for the style map 210 and the style features using the vision transformers. A neighbor embedding model that reduces the dimensionality can identify the distinct styles and the style features. Accordingly, the neighbor embedding model improves efficiency for the ML pipeline 300 by reducing computation times through processing in a space having lower dimensionality.

Moreover, the style stage 310 includes dimensionality reduction computations (e.g., t-distributed stochastic neighbor embedding (t-SNE)). Here, the design system 100 reduces complexity for analyzing and visualizing images by projecting data to a lower-dimensional space, thereby reducing computation times and improving data compression. The processing by the style stage 310 continues by clustering data about the images using k-means in the lower-dimensional space and generating style clusters. A cluster outcome may correspond to a distinct style group within the style map 210. As previously explained, users (e.g., stakeholders, consumers, managers, etc.) can select the number of distinct styles for viewing as feedback, such as by adjusting a slide bar on the interface 200. For example, dragging the slide bar left reduces or alters clustering. In this way, the users dynamically interact with data points and plots that are subsequently mapped on the comparison map 220 for efficient design from the image dataset. According to a number (k), the design system 100 updates results from k-means and reflects the updates on the style map 210. In one approach, the management module 130 prompts users to view actual images of design samples (e.g., hovering over a data point) and select samples for display on the comparison map 220. Accordingly, the style stage 310 efficiency allows design exploration and inspires designs using machine learning.

Regarding details about the comparison map 220, the comparison stage 320 of the ML pipeline 300 includes scoring dimensions representing semantic attributes on the x-axis and y-axis according to a scoring dataset or a learning model that estimates scores. As previously explained, the comparison map 220 can display images on a 2D spatial layout by factoring quantitative values associated with semantic attributes (e.g., sporty, luxury, rugged, etc.). For example, the design system 100 acquires metrics associated with the semantic attributes from human feedback (e.g., ratings) of images or estimates the metrics dynamically with a learning model (e.g., a data-driven model, CLIP, a vision and language model, etc.). Furthermore, semantic attributes may be interpretable about the images selected and factor metrics that include certain behavioral, attitudinal, and physiological responses of individuals (e.g., a consumer history of interacting with a product webpage). Regarding estimating scoring, a learning model may classify the images selected from the style map 210 to semantic attributes. As such, the design system 100 can derive scores from estimating probabilities according to the classifications. In various implementations, the learning model projects images and semantic attributes to a share vector space. A semantic distance between an image and a sematic attribute may be a quantitative measure of relatedness. For instance, the semantic distances are derived from a vector space that is shared where related images and semantics have similar scores. In this way, the comparison stage 320 can incorporate scores from humans and/or a learning model, thereby improving design choices through diverse feedback.

In one approach, the design system 100 increases the dimensions to form a three-dimensional (3D) space for the selected images, thereby expanding design capabilities and knowledge involving complex designs. In further examples, the comparison stage 320 uses dimensions beyond 3D such as by including time, demographics, etc. The comparison stage 320 adapts scoring of the semantic attributes using the scoring dataset or computations updated from changing dimensions. Furthermore, in another approach, the ML pipeline 300 iteratively generates new designs as multiple users toggle inputs between the style map 210 and the comparison map 220, thereby providing dynamic control within the design system 100.

In various implementations, a mixing stage includes an interpolation model 330 as a generative process that receives the starting points and end points of selected images for the mixing panel 240. In one approach, the interpolation model 330 implements a latent diffusion model (LDM) that efficiently generates images by integrating visual elements between multiple images at different proportions (e.g., 25/75, 50/50, 75/25, etc.), such as with internal representations that are vectorized. For example, the LDM is zero-shot network that generates blended images from vast sources without pre-training. In another approach, the design system 100 interpolates by combining pixels between images for generative processing that conserves computing resources. The mixing stage outputs may include an array from the interpolation model 330 having slices of stylized images at the different proportions. Here, the design system 100 may implement an edge detection model to constrain the slices by pose for exhibiting stylized images that are related while having distinctions. Accordingly, designers can select various quantities of interpolated images as a new input image to efficiently generate diverse combination of images for further experimentation and exploration.

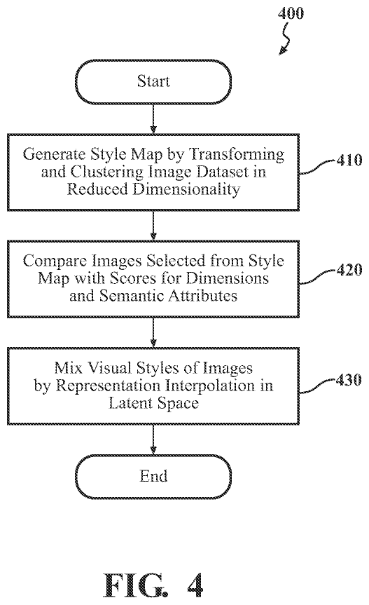

Now turning to FIG. 4, one embodiment of a method 400 that is associated with generating a style map, comparing images, and mixing visual style by ML models for the design system is illustrated. Method 400 will be discussed from the perspective of the design system 100 of FIG. 1. While method 400 is discussed in combination with the design system 100, it should be appreciated that the method 400 is not limited to being implemented within the design system 100 but is instead one example of a system that may implement the method 400.

At 410, the design system 100 generates the style map by transforming and clustering an image dataset within a space having reduced dimensionality. Here, the design system 100 includes a style stage within a ML pipeline processes the image dataset that is extensive with a visualization model (e.g., visual transformer model, a neural network (NN), a color distribution model, etc.) that extracts visual features. As previously explained, the style stage may include source vision transformers (ViT) that implement self-attention processing for identifying distinct styles from the image dataset. Furthermore, the style stage may include a neighbor embedding model that reduces the dimensionality through projecting data for identifying the distinct styles and style features from the image dataset. Therefore, the neighbor embedding model improves efficiency for the ML pipeline by reducing computations cycles through processing within a space having lower dimensionality.

Moreover, the style stage continues by clustering data from the image dataset and generating style clusters, such as with k-means functions in a lower-dimensional space. A cluster outcome may correspond to a group having a distinct style within the style map. As previously explained, users (e.g., stakeholders, consumers, managers, etc.) can select styles for viewing as feedback, such as through adjusting a slide bar on an interface displaying the style map. For example, dragging the slide bar right increases or alters clustering of styles that the design system 100 identified. Here, the design system 100 updates results from k-mean operations and reflects the updates on the style map according to a number k. In this way, users can dynamically interact with data points and plots that are subsequently mapped on a comparison map for efficient design from the image dataset.

Regarding further details on clustering, the design system 100 maps style features in clusters according to visual features following selected styles 1 . . . n. An interface generated may allow style selections with a style bar, a dial, a drop box, a text field(s), or any other interface control for selected styles 1 . . . n. In one approach, the management module 130 prompts users to view actual images of design samples (e.g., hovering over a data point) within clusters and select samples for display on the comparison map. Accordingly, the design system 100 includes ML models that execute computations to identify, cluster, and map visual features efficiently from an image dataset that is diverse and vast, thereby improving design creativity.

At 420, the management module 130 compares images selected from the style map using scoring for dimensions associated with semantic attributes. Here, a comparison stage of the ML pipeline 300 includes scoring dimensions representing the semantic attributes on the x-axis and y-axis. The scoring may be acquired from a scoring dataset or a learning model that estimates scores. For example, the design system 100 acquires metrics associated with the semantic attributes from human feedback of images. As previously explained, in one approach, the design system 100 estimates the metrics dynamically with a learning model. Semantic attributes may be interpretable about the images and factor metrics that include certain behavioral, attitudinal, and physiological responses of individuals. Regarding estimating scoring, the design system 100 can derive scores from estimating classifications or semantic distances. For example, a semantic distance between a selected image and a semantic attribute is a quantitative measure of relatedness derived from a vector space that is shared. The vector space identifies related images through similar scoring. In this way, the learning model mimics human interpretations about designs that diversify exploration by the design system 100.

In various implementations, the design system 100 increases the dimensions of the comparison map and forms a 3D space for the selected images, thereby expanding design capabilities, knowledge, and perception, particularly with complex designs. The comparison stage can adapt scoring of the semantic attributes using the scoring dataset or computations updated from changing dimensions. As an additional enhancement, the ML pipeline iteratively generates new designs as multiple users toggle inputs between the style map and the comparison map. In this way, the design system 100 allows dynamically creating diverse designs involving multiple users while maintaining system efficiency.

At 430, the design system 100 mixes visual styles of the images by representation interpolation in the latent space. In various implementations, a mixing stage executes generative processing with an interpolation model. The mixing stage can receive the starting points and end points of selected images and generate a mixing panel displaying outputs. In one approach, the interpolation model implements a LDM that integrates and blends visual elements between multiple images at different proportions (e.g., 25/75, 50/50, 75/25, etc.). The LDM may execute these tasks using internal representations of the images that are vectorized, thereby simplifying computations. Regarding outputs, the mixing stage may generate an array from the interpolation having slices of stylized images reflecting the different and various proportions. As previously explained, the design system 100 may implement an edge detection model to constrain the slices by pose for exhibiting stylized images that are related while having distinctions. Accordingly, the design system 100 uses a ML pipeline to identify style features and integrate external insights using scoring for designs, thereby reducing development times and increasing efficiency through more reliable and effective collaboration among stakeholders.

Detailed embodiments are disclosed herein. However, it is to be understood that the disclosed embodiments are intended as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Furthermore, the terms and phrases used herein are not intended to be limiting but rather to provide an understandable description of possible implementations. Various embodiments are shown in FIGS. 1-4, but the embodiments are not limited to the illustrated structure or application.

The flowcharts and block diagrams in the figures illustrate the architecture, functionality, and operation of possible implementations of systems, methods, and computer program products according to various embodiments. In this regard, a block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein.

The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a ROM, an EPROM or flash memory, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an ASIC, a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the present arrangements may be written in any combination of one or more programming languages, including an object-oriented programming language such as Java™, Smalltalk™, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all combinations of one or more of the associated listed items. As an example, the phrase “at least one of A, B, and C” includes A, B, C, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A design system comprising:
a memory storing instructions that, when executed by a processor, cause the processor to:
generate a style map by transforming and clustering information from an image dataset with a visualization model within a computation space having reduced dimensionality, and the style map includes style features derived from the image dataset;
compare images selected from the style map using scores for dimensions associated with semantic attributes to form a comparison map;
mix visual styles of the images from the comparison map with a generative model that computes representation interpolations within a latent space, the generative model outputting stylized images in an array; and
communicate the array to a development system.

2. The design system of claim 1 further including instructions to compute the scores by acquiring coordinate values for the dimensions, and the semantic attributes represent interpretable qualities about the images.

3. The design system of claim 2, wherein the instructions to compute the scores further include instructions to:
estimate semantic distances of the images according to the semantic attributes by a learning model.

4. The design system of claim 2, wherein the instructions to compute the scores further include instructions to:
classify the images to estimate the scores by a learning model; and
increase the dimensions to form a three-dimensional (3D) space for the images.

5. The design system of claim 1, wherein the instructions to generate the style map further include instructions to:
extract distinct styles about the images by the visualization model for the style map and the style features using a vision transformer; and
identify the distinct styles and the style features using a neighbor embedding model that reduces the dimensionality.

6. The design system of claim 5 further including instructions to:
alter the clustering of the images according to the distinct styles that are selected.

7. The design system of claim 1, wherein the instructions to mix the visual styles further include instructions to:
compute the array by the generative model partly with a latent diffusion model that is zero-shot and processes internal representations of the images into various proportions, the array having slices of the stylized images according to the various proportions that are constrained by a pose.

8. The design system of claim 1, wherein the scores factor feedback acquired from one of decision-makers, designers, and stakeholders.

9. A non-transitory computer-readable medium comprising:
instructions that when executed by a processor cause the processor to:
generate a style map by transforming and clustering information from an image dataset with a visualization model within a computation space having reduced dimensionality, and the style map includes style features derived from the image dataset;
compare images selected from the style map using scores for dimensions associated with semantic attributes to form a comparison map;
mix visual styles of the images from the comparison map with a generative model that computes representation interpolations within a latent space, the generative model outputting stylized images in an array; and
communicate the array to a development system.

10. The non-transitory computer-readable medium of claim 9 further including instructions to compute the scores by acquiring coordinate values for the dimensions, and the semantic attributes represent interpretable qualities about the images.

11. The non-transitory computer-readable medium of claim 10 wherein the instructions to compute the scores further include instructions to:
estimate semantic distances of the images according to the semantic attributes by a learning model.

12. The non-transitory computer-readable medium of claim 9 wherein the instructions to generate the style map further include instructions to:
extract distinct styles about the images by the visualization model for the style map and the style features using a vision transformer; and
identify the distinct styles and the style features using a neighbor embedding model that reduces the dimensionality.

13. A method comprising:
generating a style map by transforming and clustering information from an image dataset with a visualization model within a computation space having reduced dimensionality, and the style map includes style features derived from the image dataset;
comparing images selected from the style map using scores for dimensions associated with semantic attributes to form a comparison map;
mixing visual styles of the images from the comparison map with a generative model that computes representation interpolations within a latent space, the generative model outputting stylized images in an array; and
communicating the array to a development system.

14. The method of claim 13 further comprising computing the scores by acquiring coordinate values for the dimensions, and the semantic attributes represent interpretable qualities about the images.

15. The method of claim 14, wherein computing the scores further includes:
estimating semantic distances of the images according to the semantic attributes by a learning model.

16. The method of claim 14, wherein computing the scores further include:
classifying the images to estimate the scores by a learning model; and
increasing the dimensions to form a three-dimensional (3D) space for the images.

17. The method of claim 13, wherein generating the style map further includes:
extracting distinct styles about the images by the visualization model for the style map and the style features using a vision transformer; and
identifying the distinct styles and the style features using a neighbor embedding model that reduces the dimensionality.

18. The method of claim 17 further comprising altering the clustering of the images according to the distinct styles that are selected.

19. The method of claim 13, wherein mixing the visual styles further includes:
computing the array by the generative model partly with a latent diffusion model that is zero-shot and processes internal representations of the images into various proportions, the array having slices of the stylized images according to the various proportions that are constrained by a pose.

20. The method of claim 13, wherein the scores factor feedback acquired from one of decision-makers, designers, and stakeholders.
